(19) United States
(12) Patent Application Publication
(10) Pub. No.: US 2014/0000151 A1
(43) Pub. Date: Jan. 2, 2014

(54) FLAT FOLDING INSECT TRAPPING STICK

(71) Applicant: James B. Cowen, Hamburg, NJ (US)

(72) Inventor: James B. Cowen, Hamburg, NJ (US)

(21) Appl. No.: 13/539,441

(22) Filed: Jun. 30, 2012

(51) Int. Cl. A01M 1/10

(52) U.S. Cl. 43/107

(57) ABSTRACT

A flat folding insect trapping stick solves the issues of conventional insect trapping sticks that require a large amount of storage and retail shelf space. The flat folding insect trapping stick can collapse to remove the dead air in the packaging of the product, resulting in a product that not only takes up less shipping, storage and retail shelf space, but also has lower fabrication costs as compared to conventional insect trapping sticks. For example, the collapsible nature of the product can take eight pallet loads of conventional insect strips down to one in storage/shipping and can permit 24 packs on the retail shelf space in the spot of six conventional insect strips.

### BACKGROUND OF THE INVENTION

The present invention relates to insect trapping sticks and, more particularly, to an insect trapping stick that can collapse to reduce the storage and shipping space needed for the product.

Currently, insect trapping strips are packaged and sold as assembled units. These units take up a large amount of storage and retail shelf space. Moreover, these conventional insect strips cost more to produce, require additional packaging, require higher freight costs, greater storage expenses—all of which result in lost retail revenue.

As can be seen, there is a need for an improved insect trapping stick that may fold to a reduced size/volume for shipping, storage and retail display.

### SUMMARY OF THE INVENTION

In one aspect of the present invention, an insect trap assembly comprises an elongated box disposable in a flattened state with adjacent sides of the box pressed against each other, the elongated box operable to be folded into a tubular box assembly; insect trapping disposed on at least one side of the elongated box; a release paper/film disposed over the insect trapping; and a hanger disposed on at least one end of the elongated box.

In another aspect of the present invention, an insect trap assembly comprises an elongated box disposable in a flattened state with adjacent sides of the box pressed against each other, the elongated box operable to be folded into a tubular box assembly; insect trapping disposed on each side of the elongated box; a release paper/film disposed over the insect trapping; a hanger disposed on at least one end of the elongated box; a plurality of fold elevation tabs extending from each side of the tubular box assembly and at each end thereof; side flaps disposed on opposite sides of an open end of the elongated box and operable to fold over the open end of the elongated box; and a main flap operable to fold over the side flaps and retain the side flaps in a closed configuration.

In a further aspect of the present invention, a method for reducing shipping, storage and retail display space of an insect trap comprises packaging the insect trap as a flattened box, where the flattened box is operable to be un-flattened into a tubular box, where the flattened box has insect trapping disposed on each side thereof and a release paper/film disposed over the insect trapping.

These and other features, aspects and advantages of the present invention will become better understood with reference to the following drawings, description and claims.

### BRIEF DESCRIPTION OF THE DRAWINGS

FIG. 1 is a perspective view of an assembled flat folding insect strip according to an exemplary embodiment of the present invention;

FIG. 2 is a side view of the flat folding insect strip of FIG. 1;

FIG. 3 is a cross sectional view taken along line 3-3 of FIG. 2;

FIG. 4 is a perspective view of the flat folding insect strip of FIG. 1, illustrated in an unfolded configuration;

FIG. 5 is a front view of the unfolded flat folding insect strip of FIG. 4;

FIG. 6 is a side view of the unfolded flat folding insect strip of FIG. 4;

FIG. 7 is a perspective view of the unfolded flat folding insect strip of FIG. 4, in a flattened configuration;

FIG. 8 is a cross sectional view taken along line 8-8 of FIG. 1;

FIG. 9 is a cross sectional view of a partially flattened flat folding insect strip;

FIG. 10 is a cross sectional view of a fully flattened flat folding insect strip;

FIG. 11 is a detail perspective view of the flat folding insect strip of FIG. 1 showing a folded elevation tab in an un-deployed configuration;

FIG. 12 is a detail perspective view of the flat folding insect strip of FIG. 1 showing the folded elevation tab in a deployed configuration;

FIG. 13 is a top view of the flat folding insect strip of FIG. 1, disposed in a corner surface;

FIG. 14 is a top perspective view of the flat folding insect strip of FIG. 1, showing a user holding the insect strip in an un-flattened configuration;

FIG. 15 is a side view of the flat folding insect strip of FIG. 1, resting on a flat surface; and

FIG. 16 is a perspective view showing a user removing release paper or film from the flat folding insect strip of FIG. 1, prior to unflattening and folding flaps into a folded configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a flat folding insect trapping stick that solves the issues of conventional insect trapping sticks that require a large amount of storage and retail shelf space. The flat folding insect trapping stick of the present invention can collapse to remove the dead air in the packaging of the product, resulting in a product that not only takes up less shipping, storage and retail shelf space, but also has lower fabrication costs as compared to conventional insect trapping sticks. For example, the collapsible nature of the product can take eight pallet loads of conventional insect trapping strips down to one in storage/shipping and can permit 24 packs on the retail shelf space in the spot of six conventional insect strips.

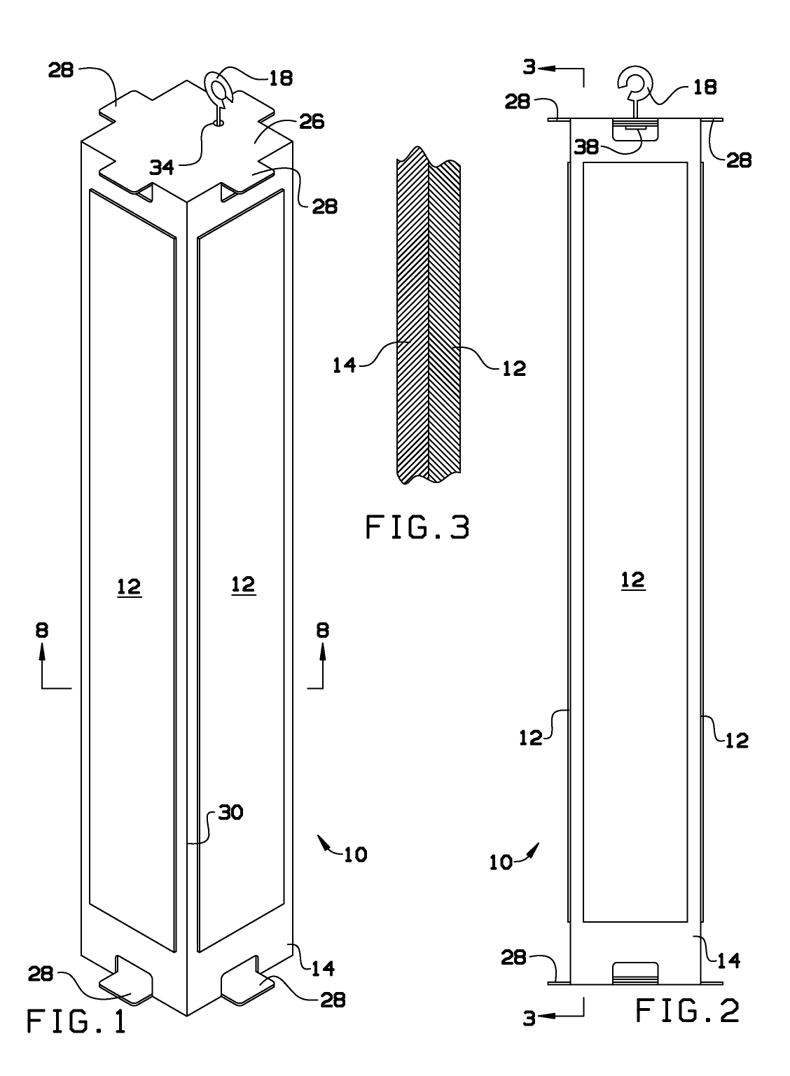

Referring now to FIGS. 1 through 16, a folding insect trap assembly 10, in an un-flattened configuration, as shown in FIGS. 1 and 2, can include a ultraviolet (UV) stable insect trapping 12 on at least one exterior surface thereof. Typically, the inset trapping 12 can be disposed on all four sides of the insect trap assembly 10. The base material of the insect trap assembly 10 can be made of various materials, such as solid bleached sulfate (SBS) paperboard. A hanger 18 may extend from at least one end of the insect trap assembly 10. The hanger 18 may be, for example, a flexible nylon hanger.

A plurality of fold elevation tabs 28 can be disposed on each end and each side of the insect trap assembly 10. The tabs 28 may extend at an angle, typically generally orthogonal, to the surface of the insect trapping 12.

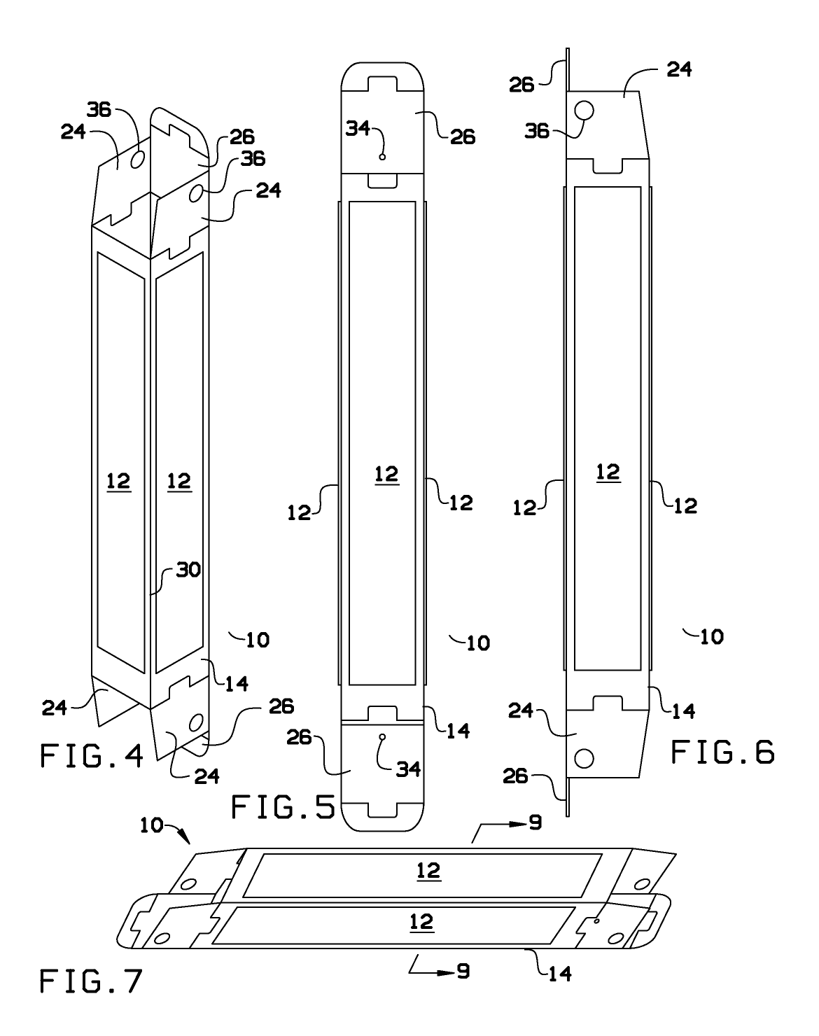

In an unfolded configuration, as shown in FIGS. 4 through 7, each end of the insect trap assembly 10 can include first and second side flaps 24 that may fold in toward each other, and a main flap 26 that may fold over and retain the side flaps 24 thereunder. Each of the side flaps 24 can contain a side flap hanger hole 36. The main flap 26 can contain a main flap hanger hole 34. The hanger holes 36, 34 can align with the insect trap assembly 10 is closed (FIGS. 1 and 2), permitting the hanger 18 to pass therethrough. In some embodiments both ends of the insect trap assembly 10 can include the hanger holes 36, 34. In other embodiments, only one end may include the hanger holes 36, 34.

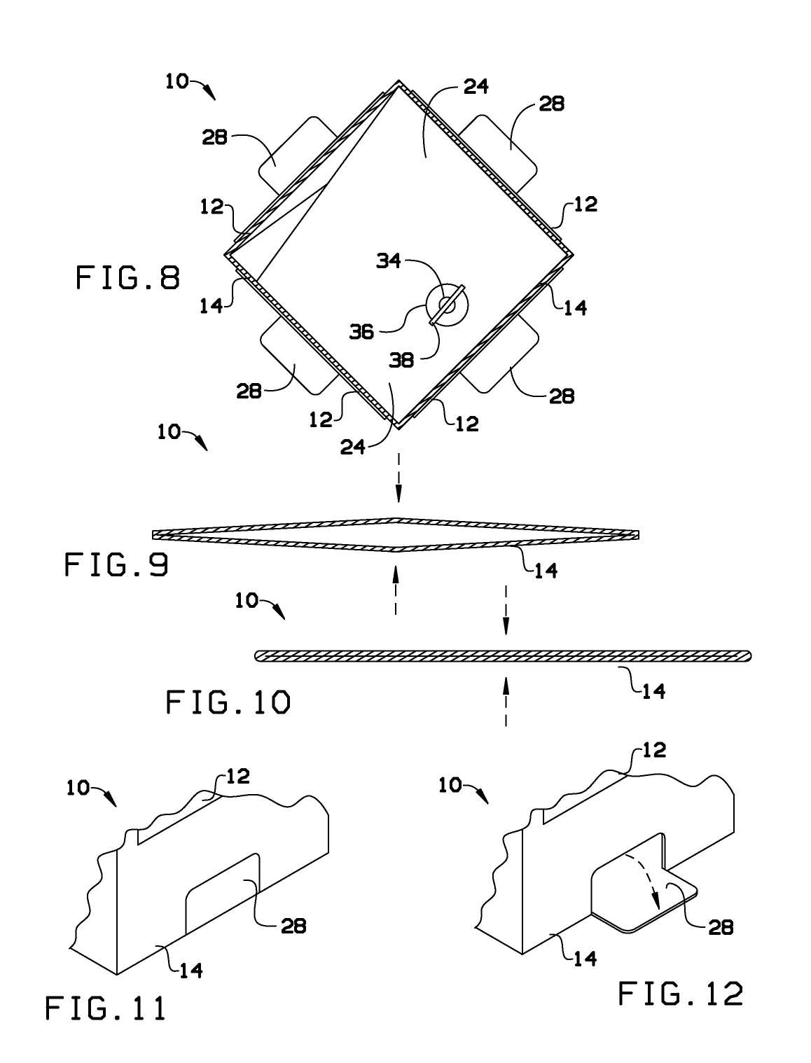

As shown in FIG. 8, the hanger 18 may pass through the main flap hanger hole 34 and the side flaps hanger holes 36. A T-handle 38 may be formed in an end of the hanger 18. The length of the T-handle 38 may be larger than the holes 34, 36 such as to retain the hanger 18 and not allow the hanger 18 to escape when the insect trap assembly 10 is hung and supported by the hanger 18.

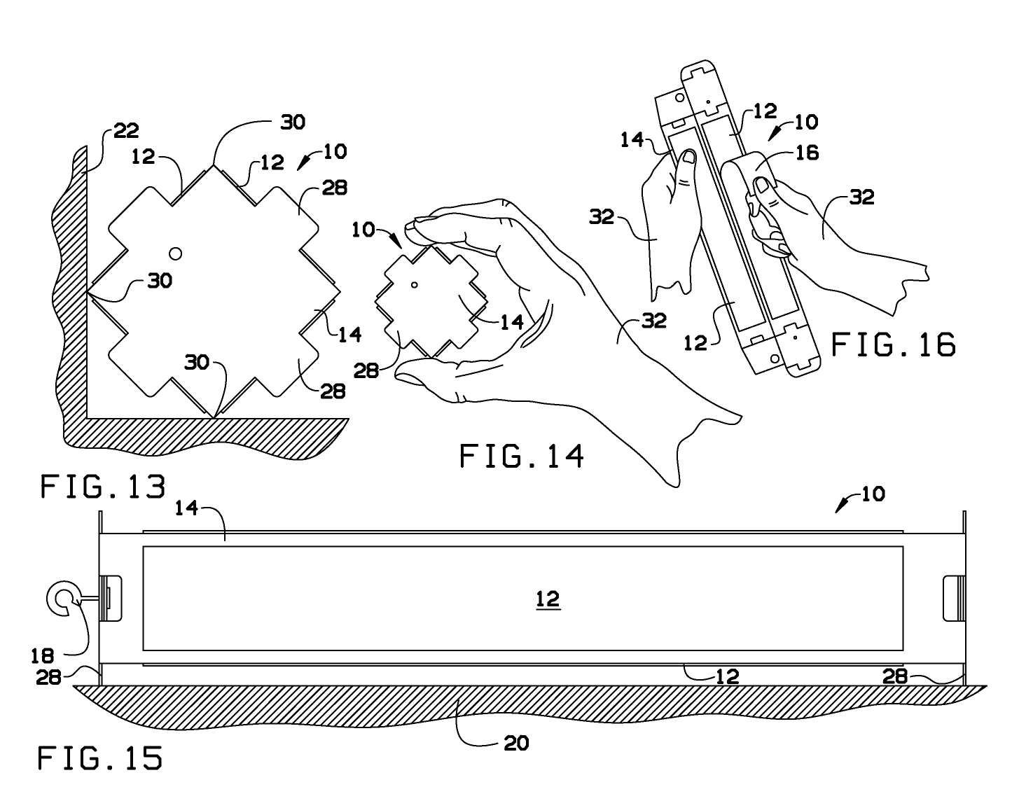

As shown in FIGS. 11 and 12, the fold elevation tabs 28 may be movable between a closed configuration (FIG. 11) and an open configuration (FIG. 12). The elevation tabs 28 may be useful to prevent the insect trapping 12 from contacting a corner wall 22, as shown in FIG. 13, or, when placed on a horizontal surface 20, from contacting the surface 20.

In some embodiments of the present invention, the insect trapping 12 is not run down the entire length of the flattened box during manufacture, but instead, only on the sides of the box. Therefore, the tuck flaps (side flaps 24 and main flap 26) are free from insect trapping 12, making it easier for the consumer to fold the box into shape prior to use. Also, it should be noted that the insect trapping 12 is not applied all the way to the edges of each side. As shown in FIG. 14, this glue-less void allows a user to handle the insect trap 10 on its corners without contacting the insect trapping 12. Similarly, when positioned in a corner, as shown in FIG. 13, these glue-less voids help prevent the insect trapping 12 from contacting and getting stuck on a wall, floor, or some similar surface. Finally, these unglued edges can form a more stable platform with the tabs 28 when the stick is laid on its side, as shown in FIG. 15.

As shown in FIG. 16, when a user 32 is ready to use the insect trap assembly 10, they may simply remove a release film or paper 16 from the insect trapping 12 and fold the insect trap assembly 10 from an unfolded configuration (FIGS. 4-7) to a folded configuration (FIGS. 1 and 2).

In some embodiments of the present invention, the insect trapping 12 can contain various materials, including insect pheromones, for example, for attracting insects thereto. In some embodiments, a controlled release pheromone dispenser could be applied on the surface or inside the insect trap assembly 10 to help attract insects.

To make the insect trap assembly of the present invention, the paperboard 14 should track under hot melt glue heads. After the gluing, the release sheet 16 can be nipped onto the glue surface 12. If the paperboard is roll feed and not sheet fed, then the piece can be guillotined off the end of the line. The next two operations on the cooled glue covered piece will include die cutting, with either steel rule dies or a rotary die, and then sending it through a box gluer to form it into a box. The last step before packaging can be to mount nylon hanging hooks on the flaps at the ends.

It should be understood, of course, that the foregoing relates to exemplary embodiments of the invention and that modifications may be made without departing from the spirit and scope of the invention as set forth in the following claims.

What is claimed is:

1. An insect trap assembly comprising:
an elongated box disposable in a flattened state with adjacent sides of the box pressed against each other, the elongated box operable to be folded into a tubular box assembly;
insect trapping disposed on at least one side of the elongated box;
a release paper/film disposed over the insect trapping; and
a hanger disposed on at least one end of the elongated box.

2. The insect trap assembly of claim 1, wherein the insect trapping is disposed on four sides of the elongated box.

3. The insect trap assembly of claim 2, wherein the insect trapping is disposed in a central region of each side of the insect trap, leaving an outer periphery of each side of the insect trap without insect trapping thereupon.

4. The insect trap assembly of claim 1, further comprising a plurality of fold elevation tabs extending from each side of the tubular box assembly and at each end thereof.

5. The insect trap assembly of claim 1, further comprising:
side flaps disposed on opposite sides of an open end of the elongated box and operable to fold over the open end of the elongated box; and
a main flap operable to fold over the side flaps and retain the side flaps in a closed configuration.

6. The insect trap assembly of claim 5, further comprising a side flap hanger hole in each of the side members and a main flap hanger hold disposed in the main flap, wherein the side flap hanger holes and the main flap hanger hole align when the side flaps and the main flap is oriented in the closed configuration.

7. The insect trap assembly of claim 6, wherein the hanger includes a T handle, retained by the side flap hanger holes and the main flap hanger hole.

8. An insect trap assembly comprising:
an elongated box disposable in a flattened state with adjacent sides of the box pressed against each other, the elongated box operable to be folded into a tubular box assembly;
insect trapping disposed on each side of the elongated box;
a release paper/film disposed over the insect trapping;
a hanger disposed on at least one end of the elongated box;
a plurality of fold elevation tabs extending from each side of the tubular box assembly and at each end thereof;
side flaps disposed on opposite sides of an open end of the elongated box and operable to fold over the open end of the elongated box; and
a main flap operable to fold over the side flaps and retain the side flaps in a closed configuration.

9. The insect trap assembly of claim 8, further comprising a side flap hanger hole in each of the side members and a main flap hanger hold disposed in the main flap, wherein the side flap hanger holes and the main flap hanger hole align when the side flaps and the main flap is oriented in the closed configuration.

10. The insect trap assembly of claim 9, wherein the hanger includes a T handle, retained by the side flap hanger holes and the main flap hanger hole.

11. A method for reducing shipping, storage and retail display space of an insect trap, the method comprising:
packaging the insect trap as a flattened box, where the flattened box is operable to be un-flattened into a tubular box, where the flattened box has insect trapping disposed on each side thereof and a release paper/film disposed over the insect trapping.

12. The method of claim 11, wherein the insect trapping is disposed in a central region of each side of the insect trap, leaving an outer periphery of each side of the insect trap without insect trapping thereupon.
